(19) United States
(12) Patent Application Publication
(10) Pub. No.: US 2012/0270490 A1
(43) Pub. Date: Oct. 25, 2012

(54) SYSTEM AND METHOD OF SHUTTER CONTROL

(75) Inventors: David Turner, Algonac, MI (US); Holly A. Houtman, Milford, MI (US)

(73) Assignee: GM GLOBAL TECHNOLOGY OPERATIONS LLC, Detroit, MI (US)

(21) Appl. No.: 13/091,250

(22) Filed: Apr. 21, 2011

(51) Int. Cl. B60H 1/00

(52) U.S. Cl. 454/75

(57) ABSTRACT

A method of controlling operation of an adjustable shutter in a vehicle includes operating the shutter between and inclusive of fully-opened and fully-closed positions to regulate an amount of ambient air flowing into the vehicle. The shutter is arranged relative to a vehicle grille opening that is adapted for receiving the flow of ambient air. The method also includes sensing via a moisture sensor a level of moisture in the ambient air. The method additionally includes selecting a first predetermined position of the shutter when the level of moisture has reached a threshold moisture value to alter the amount of ambient air flowing into the vehicle through the shutter. A vehicle using a controller to perform such a method is also provided.

### TECHNICAL FIELD

The invention relates to a system and a method of shutter control.

### BACKGROUND

A shutter is typically a solid and stable covering for an opening. A shutter frequently consists of a frame and louvers or slats mounted within the frame.

Louvers may be fixed, i.e., having a permanently set angle with respect to the frame. Louvers may also be operable, i.e., having an angle that is adjustable with respect to the frame for permitting a desired amount of light, air, and/or liquid to pass from one side of the shutter to the other. Depending on the application and the construction of the frame, shutters can be mounted to fit within, or to overlap the opening. In addition to various functional purposes, particularly in architecture, shutters may also be employed for largely ornamental reasons.

In motor vehicles, a shutter may be employed to control and direct a stream of air to various vehicle compartments and/or subsystems. Therefore, a shutter may be employed to enhance operation of a range of vehicle systems, as well as comfort of vehicle passengers. However, when the stream of air enters the vehicle from the ambient, the airstream may also carry a significant amount of moisture potentially undesirable to some vehicle subsystems.

### SUMMARY

A method of controlling operation of an adjustable shutter in a vehicle includes operating the shutter between and inclusive of fully-opened and fully-closed positions to regulate an amount of ambient air flowing into the vehicle. The shutter is arranged relative to a vehicle grille opening that is adapted for receiving the flow of ambient air. The method also includes sensing via a moisture sensor a level of moisture in the ambient air. The method additionally includes selecting a first predetermined position of the shutter when the level of moisture has reached a threshold moisture value to alter the amount of ambient air flowing into the vehicle through the shutter.

The vehicle may include a controller. In such a case, each of said operating the shutter and selecting the predetermined position of the shutter may be accomplished by the controller. Furthermore, the controller may regulate a shutter mechanism that is configured to adjust the shutter between and inclusive of the fully-opened and the fully-closed positions.

The method may also include communicating by the moisture sensor to the controller a signal indicative of the sensed level of moisture.

The method may additionally include monitoring an ambient temperature by the controller and operating the mechanism to select and lock a second predetermined position of the shutter in response to the ambient temperature being below a predetermined value.

The vehicle may also include an internal combustion engine and an air intake configured to channel into the engine at least a portion of the amount of ambient air flowing into the vehicle. According to the method, the selection of the first predetermined position of the shutter may additionally alter the level of moisture in the at least a portion of the amount of ambient air flowing into the vehicle that is channeled into the engine. The air intake may be characterized by an absence of baffles configured to substantially separate the flow of ambient air from the moisture.

The method may also include monitoring a temperature of the engine by the controller. In such a case, operation of the shutter may be accomplished in response to a change in the temperature of the engine.

According to the method, the threshold moisture value may be near 100% humidity and the first predetermined position of the shutter may be that of fully-closed.

The shutter may be arranged one of integral to the grille opening and adjacent to the grille opening.

A vehicle using a controller to perform such a method is also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a partial side cross-sectional view of a vehicle having a shutter depicted in a fully closed state;

FIG. 2 is a partial side cross-sectional view of a vehicle having the shutter shown in FIG. 1, with the shutter depicted in an intermediate state;

FIG. 3 is a partial side cross-sectional view of a vehicle having the shutter system shown in FIGS. 1 and 2, with the shutter depicted in a fully opened state; and

FIG. 4 is a flow chart illustrating a method of controlling operation of the adjustable shutter depicted in FIGS. 1-3.

### DETAILED DESCRIPTION

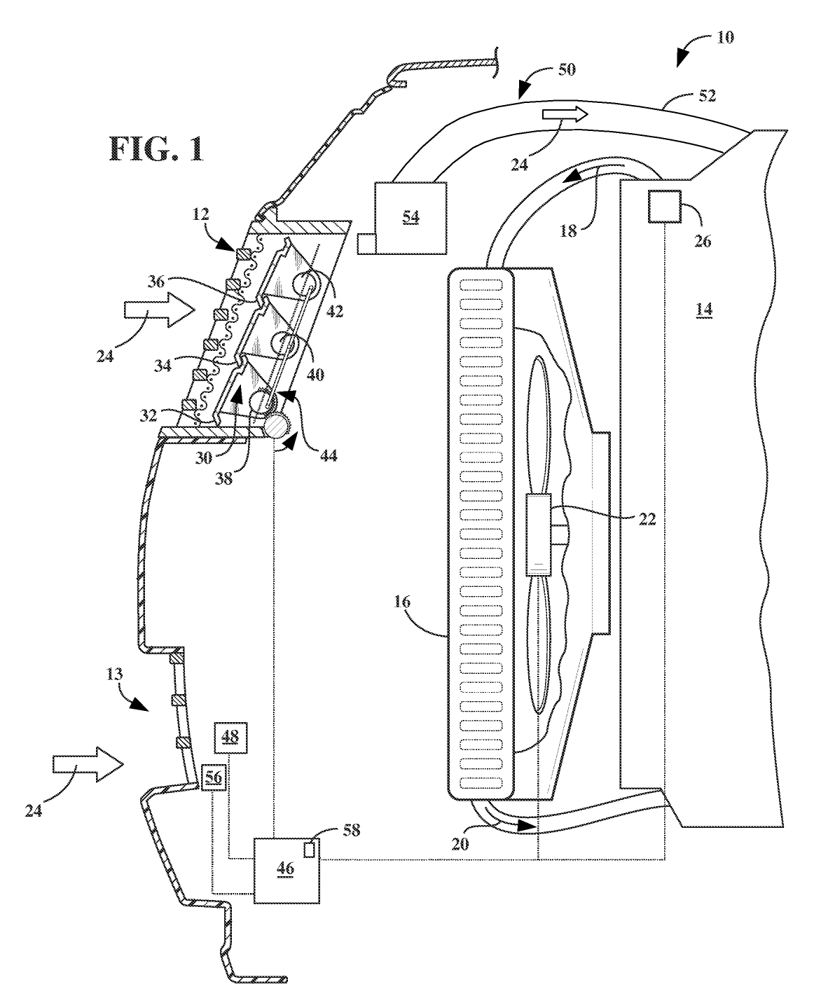

Referring to the drawings, wherein like reference numbers refer to like components, FIGS. 1-3 show a partial side view of a vehicle 10. The vehicle 10 is shown to include a grille opening 12 typically covered with a mesh. The grille opening 12 is adapted for receiving ambient air. The vehicle 10 additionally includes a powertrain that is specifically represented by an internal combustion engine 14. The powertrain of the vehicle 10 may additionally include a transmission, and, if the vehicle is a hybrid type, one or more motor-generators, none of which is shown, but the existence of which can be appreciated by those skilled in the art. Efficiency of a vehicle powertrain is generally influenced by its design, as well as by the various loads the powertrain sees during its operation.

The vehicle 10 additionally includes an air-to-fluid heat exchanger 16, i.e., a radiator, for circulating a cooling fluid shown by arrows 18 and 20, such as water or a specially formulated coolant, though the engine 14 to remove heat from the engine. A high-temperature coolant entering the heat exchanger 16 is represented by the arrow 18, and a reduced-temperature coolant being returned to the engine is represented by the arrow 20. The heat exchanger 16 is positioned behind the grille opening 12 for protection of the heat exchanger from various road-, and air-borne debris. The heat exchanger 16 may also be positioned in any other location, such as behind a passenger compartment, if, for example, the vehicle has a rear or a mid-engine configuration, as understood by those skilled in the art.

As shown in FIGS. 1-3, a fan 22 is positioned in the vehicle 10, behind the heat exchanger 16, such that the heat exchanger 16 is positioned between the grille opening 12 and the fan. The fan 22 is capable of being selectively turned on and off based on the cooling needs of the engine 14. Depending on the road speed of the vehicle 10, the fan 22 is adapted to either generate or enhance a flow of ambient air or airflow 24 through the grille opening 12, and toward and through the heat exchanger 16. Thus generated or enhanced through the action of the fan 22, the airflow 24 is passed through the heat exchanger 16 to remove heat from the high-temperature coolant 18 before the reduced-temperature coolant 20 is returned to the engine 14. The vehicle 10 additionally includes a coolant sensor 26 configured to sense a temperature of the high-temperature coolant 18 as it exits the engine 14.

FIGS. 1-3 also depict a rotatable or adjustable shutter 30. The shutter 30 is secured in the vehicle 10 and is adapted to regulate an amount of the airflow 24 entering or flowing into the vehicle through the grille opening 12. As shown, the shutter 30 is positioned behind, and immediately adjacent to the grille opening 12 at the front of the vehicle 10. As shown, the shutter 30 is positioned between the grille opening 12 and the heat exchanger 16. The shutter 30 may also be incorporated into and be integral with the grille opening 12. The shutter 30 includes a plurality of louvers, herein shown as having three individual louver elements 32, 34, and 36, but the number of louvers may either be fewer or greater.

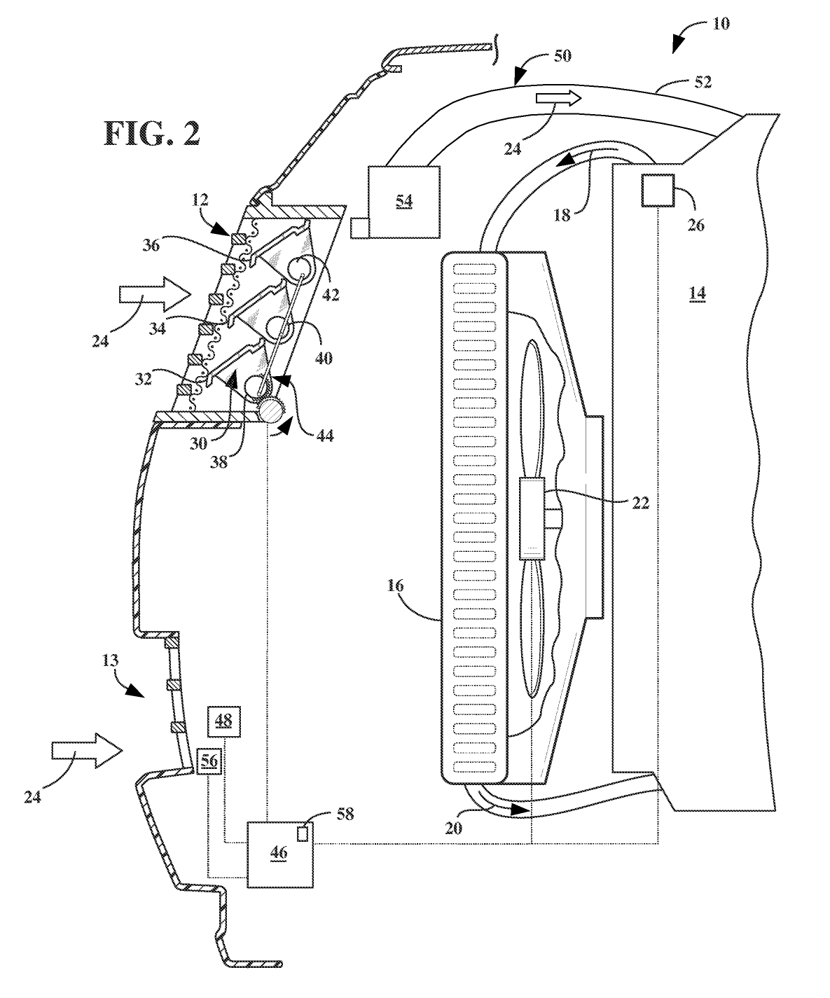

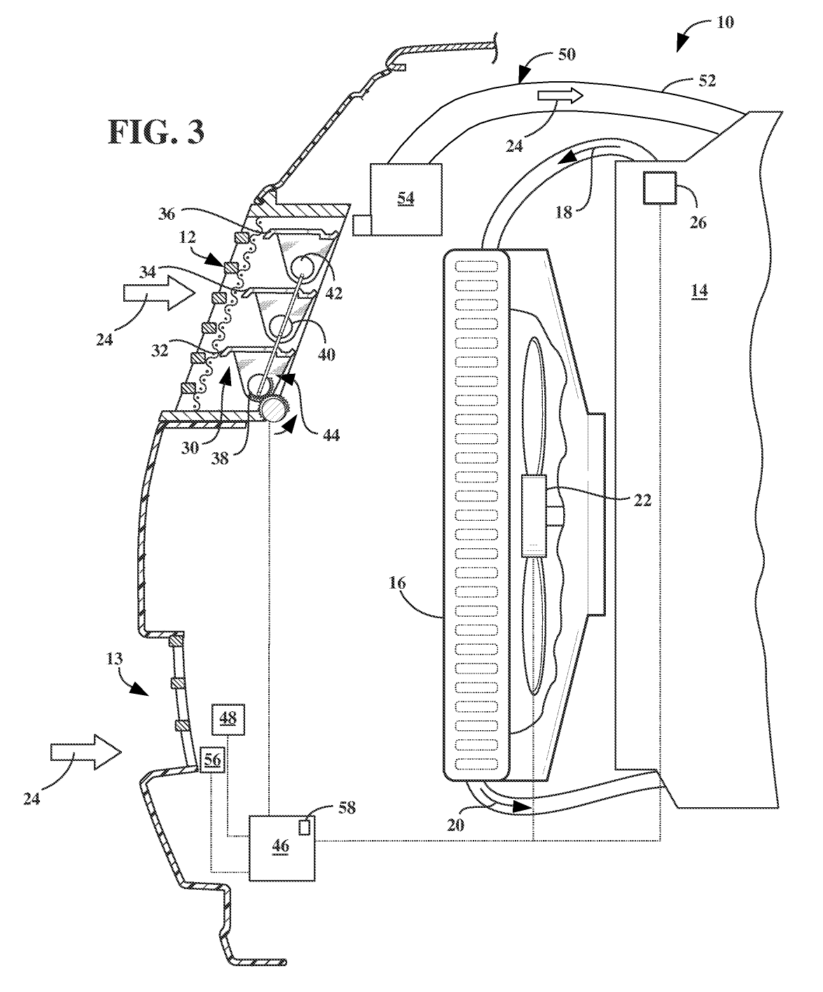

Each louver 32, 34, and 36 is configured to rotate about a respective pivot axis 38, 40, and 42 during operation of the shutter 30, thereby effectively controlling the size of the grille opening 12 and the amount of ambient air flowing into the vehicle. The shutter 30 is adapted to operate between and inclusive of a fully-closed position or state (as shown in FIG. 1), through an intermediate or partially-closed position (as shown in FIG. 2), and to a fully-opened position (as shown in FIG. 3). When the louver elements 32, 34, and 36 are in any of their open positions, the airflow 24 enters the vehicle 10 by penetrating the plane of shutter 30 before coming into contact with the heat exchanger 16.

The shutter 30 also includes a mechanism 44 configured to adjust the shutter, and thereby select and lock a desired position of the shutter between and inclusive of fully-opened and fully-closed. The mechanism 44 is configured to cause the louvers 32-36 to rotate in tandem, i.e., substantially in unison, and permitting the shutter 30 to rotate into any of the available positions. The mechanism 44 may be adapted to select and lock either discrete intermediate position(s) of the louvers 32-36, or to infinitely vary position of the louvers between and inclusive of the fully-opened and fully-closed. The mechanism 44 acts to select the desired position for the shutter 30 when activated by any external means, as understood by those skilled in the art, such as an electric motor (not shown). The vehicle 10 also includes a controller 46, which may be an engine controller or a separate control unit, configured to operate the mechanism 44 for selecting the desired position of the shutter 30. The controller 46 may also be configured to operate the fan 22, if the fan is electrically driven, and a thermostat (not shown) that is configured to regulate the circulation of coolant, as understood by those skilled in the art.

The controller 46 is programmed to operate the mechanism 44 according to the load on the engine 14 and, correspondingly, to the temperature of the coolant sensed by the sensor 26. The temperature of the high-temperature coolant 18 is increased due to the heat produced by the engine 14 under load. As known by those skilled in the art, a load on the engine 14 is typically dependent on operating conditions imposed on the vehicle 10, such as going up a hill and/or pulling a trailer. The load on the engine 14 generally drives up the internal temperature of the engine, which in turn necessitates cooling of the engine for desired performance and reliability. Typically, the coolant is continuously circulated by a fluid pump (not shown) between the engine 14 and the heat exchanger 16.

When the shutter 30 is fully-closed, as depicted in FIG. 1, the louvers 32-36 provide blockage of the airflow 24 at the grille opening 12. A fully-closed shutter 30 provides optimized aerodynamics for the vehicle 10 when engine cooling through the grille opening 12 is not required. The shutter 30 may also be operated by the controller 46 to variably restrict access of the oncoming airflow 24 to the heat exchanger 16, by rotating the louvers 32-36 to an intermediate position, as shown in FIG. 2, where the louvers are partially closed. An appropriate intermediate position of the louvers 32-36 is selected by the controller 46 according to a programmed algorithm to thereby affect the desired cooling of the engine 14. When the shutter 30 is fully-opened, as shown in FIG. 3, each louver 32-36 is rotated to a position parallel to the airflow 24 seeking to penetrate the shutter system plane. Thus, a fully-opened shutter 30 is configured to permit a generally unfettered passage of such a stream of air through the louver plane of the shutter 30.

The vehicle 10 additionally includes an air intake 50. The air intake 50 is configured to channel into the engine 14 at least a portion of the amount of airflow 24 that is admitted into the vehicle 10 by the shutter 30. The air intake 50 includes an air duct 52 and an air box 54. The air box 54 houses an air filter (not shown) that is configured to remove airborne dust and debris in order to preclude such contaminants from entering combustion chambers of the engine 14. Thus filtered and afterward channeled into the engine 14, the airflow 24 is combined with an appropriate amount of fuel inside the engine's combustion chambers (not shown).

In situations when ambient conditions include precipitation, such as rain and/or snow, the airflow 24 entering the vehicle 10 via the grille opening 12 may correspondingly include a considerable amount of moisture. During such rainy or snowy conditions, the level of moisture in the ambient air nears the 100% humidity mark. Having such high levels of moisture in the airflow 24 is sufficient to result in actual liquid entering the combustion chambers of the engine 14 through the air intake 50. However, permitting any substantial amount of liquid to enter the engine 14 is generally undesirable, because such liquid may dilute the air-fuel mixture inside the combustion chambers and adversely affect operation of the engine. Additionally, because liquid is largely incompressible, a sufficiently high amount of liquid inside the combustion chambers may induce hydro-lock. With respect to internal combustion engines, hydro-lock is a condition that results when the engine attempts to turn while the contents of its combustion chambers cannot be sufficiently compressed, which may result in damage to such engine components as connecting rods.

As shown in FIG. 1, the vehicle 10 also includes a moisture sensor 56. The moisture sensor 56 is configured to sense a level of moisture in the ambient air. The moisture sensor 56 is positioned in the front of the vehicle 10 where the airflow 24 may access the sensor directly (as shown in FIGS. 1-3), such as behind a grille opening 13, whether the shutter 30 is fully-closed or otherwise. Although not shown, to achieve the desired result the moisture sensor 56 may also be located in the air intake 50 or be configured as an optical sensor employed to detect moisture deposited on the windshield of the vehicle 10 for actuation of the vehicle windshield wipers. The moisture sensor 56 is additionally configured to generate a signal indicative of the sensed level of moisture and communicate such a signal to the controller 46.

The controller 46 is adapted to acquire the signal generated by the moisture sensor 56. Additionally, the controller is configured to select a first predetermined position of the shutter 30 to alter the amount of airflow 24 entering the air intake 50 directly from the ambient when the sensed level of moisture has reached a threshold moisture value 58. Accordingly, the threshold moisture value 58 is programmed into the controller 46 such that the controller may operate the mechanism 44 to restrict the entry of the airborne liquid into the air intake 50. If the moisture sensor 56 is configured as the optical sensor described above, the actuation of the vehicle's windshield wipers and the time elapsed since the windshield wipers have been actuated last may serve as an input to the controller 46 for selecting the position of the shutter 30. Additional inputs to the controller 46 for selecting the position of the shutter 30 may include such measurable values as vehicle speed, ambient temperature, duty cycle of the fan 22, amount of time elapsed since the threshold moisture value 58 has been sensed last, and temperature and mass flow of the air entering the air intake 50.

For example, when the threshold moisture value 58 is substantially near 100% humidity the controller 46 may entirely block the entry of the airflow 24 into the vehicle 10 through the grille opening 12 via the fully-closed shutter 30, as shown in FIG. 1. Thus, the fully-closed position of the shutter 30 may be selected as the first predetermined position of the shutter during such an ambient condition as heavy rain or if the vehicle 10 traverses a flooded road. Furthermore, when the first predetermined position of the shutter 30 is selected as that of fully-closed, substantially all of the airflow 24 is prevented from entering the vehicle 10 through the shutter. Accordingly, the ambient moisture being carried by the airflow 24 is also restricted from entering the vehicle 10 directly through the shutter 30 and being channeled by the air intake 50 into the engine 14. A second predetermined position of the shutter 30 may also be selected if the amount of moisture in the airflow 24 is below the threshold moisture value 58 but above some other predetermined intermediate value, such as during light to moderate rain conditions. The second predetermined position of the shutter 30 may thus be the partially-closed position shown in FIG. 2.

Although the fully-closed position of the shutter 30 would substantially block-off entry of the airflow 24 into the vehicle 10 through the grille opening 12, a sufficient supply of air may still be obtained by the air intake 50. When the shutter 30 is placed in the fully-closed position, the air intake 50 may obtain engine air either from the engine compartment area or from the ambient via an indirect path that limits the amount of ambient moisture being aspirated by the engine 14. As the airflow 24 is forced to take a less direct path into the air intake 50, a large part of the airborne water is separated from the airflow as the flow of air is forced to make sharp turns and is thus prevented from reaching the engine 14. Accordingly, when the position of the shutter 30 is changed away from the fully-opened position (as represented by FIGS. 1 and 2), the level of moisture that reaches the air intake 50 is altered in comparison with the level of moisture contained in the ambient.

The regulation of the amount of airflow 24 entering the air intake 50 through the grille opening 12 at increased levels of humidity described above may permit the air intake to be characterized by an absence of internal baffles. As used with respect to air intakes of internal combustion engines, the term “baffle” constitutes a barrier that is incorporated into the air duct and/or the air box to substantially separate the flow of incoming ambient air from the moisture contained therein. A baffle inside an air intake typically redirects the flow of incoming ambient air sufficiently sharply such that the considerably heavier liquid carried by the airflow fails to change direction with the speed of the air. As a result, the liquid is caused to be separated from, be left behind the flow of air, and to settle proximate the baffle in order to be removed or drained from the air intake by some additionally provided means.

Ambient temperatures near and below freezing may present considerations for cooling of the powertrain in the vehicle 10. When the ambient temperature is below a predetermined value, i.e., near or below freezing, sufficient cooling of the engine 14 may be achieved with the grille opening 12 either in the partially restricted or in the fully blocked state. At the same time, the louvers 32-36 and the mechanism 44 may freeze and become jammed at such low temperatures. Therefore, in order to prevent jamming of the shutter 30 in some unwanted position, when the ambient temperature is below the predetermined value, an appropriate second predetermined position of the shutter 30 may be selected and locked without regard to vehicle speed and load. The grille opening 12 may be placed in any position between and inclusive of the fully open and the fully restricted states via the predetermined position of the shutter 30 depending on the cooling requirements of the powertrain of the vehicle 10.

The second predetermined locked position or a number of discrete locked positions of the shutter 30 that would still permit sufficient cooling of the powertrain near and below freezing ambient temperatures may be established empirically during testing and development of the vehicle 10. The controller 46 may be employed to monitor the ambient temperature via a temperature sensor 48 and regulate and lock the position of the shutter 30 via the mechanism 44 in response to the ambient temperature being below the predetermined value. Similarly to the first predetermined position of the shutter 30, the second predetermined locked position may be that of the fully-closed position shown in FIG. 1.

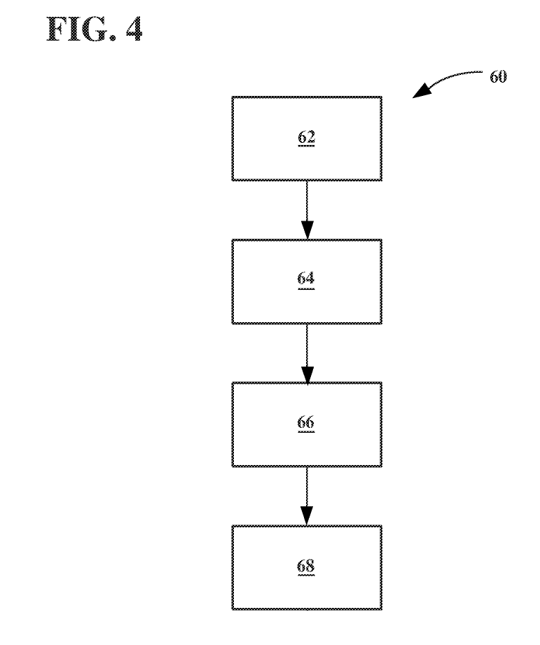

FIG. 4 depicts a method 60 controlling operation of the shutter 30, as described above with respect to FIGS. 1-3. The method commences in frame 62 and then proceeds to frame 64 where it includes operating the shutter 30 between and inclusive of fully-opened and fully-closed positions to regulate the amount of ambient airflow 24 entering the vehicle 10. In frame 64, the controller 46 may be responsible for operating the shutter 30. Following frame 64, the method advances to frame 66. In frame 66, the method includes sensing via the moisture sensor 56 a level of moisture in the airflow 24. Additionally, in frame 66 the moisture sensor 56 may communicate a signal indicative of the sensed level of moisture to the controller 46.

As described above with respect to FIGS. 1-3, inputs to the controller 46 for selecting the position of the shutter 30 may include additional measurable or sensed values. Such values may include data for vehicle speed, ambient temperature, duty cycle of the fan 22, amount of time elapsed since the threshold moisture value 58 has been sensed and/or windshield wiper has been actuated last, and temperature and mass flow of the air entering the air intake 50.

Following frame 66, the method proceeds to frame 68. In frame 68, the method includes selecting the first predetermined position of the shutter 30 when the level of moisture has reached the threshold moisture value 58. Thus selecting the first predetermined position of the shutter 30 permits the method to alter the amount of ambient airflow that enters the vehicle 10 through the grille opening 12. According to the method, the controller 46 may be responsible for selecting the first predetermined position of the shutter 30 to alter the amount of ambient airflow 24 that enters the vehicle 10 directly through the shutter.

As described with respect to FIGS. 1-3, the vehicle 10 includes the engine 14 having the air intake 50. Accordingly, altering or restricting the amount of ambient airflow 24 that enters the vehicle 10 directly through the shutter 30 would also alter the path of the airflow that enters the air intake 50. Consequently, the level of moisture being channeled into the engine 14 in comparison with the level of moisture contained in the ambient air would also be reduced. Additionally, as noted above, because the airflow 24 entering the vehicle 10 through the grille opening 12 may be blocked off by the shutter 30 during ambient conditions characterized by high humidity, the air intake 50 may be characterized by the absence of internal baffles.

While the best modes for carrying out the invention have been described in detail, those familiar with the art to which this invention relates will recognize various alternative designs and embodiments for practicing the invention within the scope of the appended claims.

1. A method of controlling operation of an adjustable shutter in a vehicle, the method comprising:
operating the shutter between and inclusive of fully-opened and fully-closed positions to regulate an amount of ambient air flowing into the vehicle, wherein the shutter is arranged relative to a vehicle grille opening adapted for receiving the ambient air flowing into the vehicle;
sensing, via a moisture sensor, a level of moisture in the ambient air; and
selecting a first predetermined position of the shutter when the level of moisture has reached a threshold moisture value to alter the amount of ambient air flowing into the vehicle through the shutter.

2. The method of claim 1, wherein the vehicle includes a controller, and wherein each of said operating the shutter and selecting the predetermined position of the shutter is accomplished by the controller.

3. The method of claim 2, wherein the shutter includes a mechanism configured to adjust the shutter between and inclusive of the fully-opened and the fully-closed positions, and wherein the mechanism is regulated by the controller.

4. The method of claim 2, further comprising communicating by the moisture sensor to the controller a signal indicative of the sensed level of moisture.

5. The method of claim 3, further comprising monitoring an ambient temperature by the controller and operating the mechanism to select and lock a second predetermined position of the shutter in response to the ambient temperature being below a predetermined value.

6. The method of claim 2, wherein the vehicle includes an internal combustion engine and an air intake configured to channel into the engine at least a portion of the amount of ambient air flowing into the vehicle, and wherein said selecting the first predetermined position of the shutter additionally alters the level of moisture in the at least a portion of the amount of ambient air flowing into the vehicle that is channeled into the engine.

7. The method of claim 6, wherein the air intake is characterized by an absence of baffles configured to substantially separate the flow of ambient air from the moisture.

8. The method of claim 6, further comprising monitoring a temperature of the engine using the controller, wherein said operating the shutter is accomplished in response to a change in the temperature of the engine.

9. The method of claim 1, wherein the threshold moisture value is near 100% humidity and the first predetermined position of the shutter is that of fully-closed.

10. A vehicle comprising:
a grille opening adapted for receiving ambient air flowing into the vehicle;
an adjustable shutter arranged relative to the grille opening, wherein the shutter includes a mechanism configured to adjust the shutter between and inclusive of the fully-opened and the fully-closed positions to selectively restrict and unrestrict the grille opening for regulating an amount of ambient air flowing into the vehicle;
an internal combustion engine;
an air intake configured to channel into the engine at least a portion of the amount of ambient air flowing into the vehicle;
a moisture sensor configured to sense a level of moisture in the ambient air and generate a signal indicative of the sensed level of moisture; and
a controller adapted to:
operate the mechanism;
acquire the signal indicative of sensed level of moisture; and
select a first predetermined position of the shutter via the mechanism when the level of moisture has reached a threshold moisture value to alter the level of moisture in the at least a portion of the amount of ambient air flowing into the vehicle that is channeled into the engine.

11. The vehicle of claim 10, wherein the air intake is characterized by an absence of baffles configured to substantially separate the flow of ambient air from the moisture.

12. The vehicle of claim 10, further comprising a sensor configured to sense a temperature of the engine and communicate the sensed temperature of the engine to the controller, and wherein the controller is additionally configured to monitor the temperature of the engine and operate the mechanism in response to a change in the temperature of the engine.

13. The vehicle of claim 10, wherein the threshold moisture value is substantially near 100% humidity and the predetermined position of the shutter is that of fully-closed.

14. The vehicle of claim 10, wherein the controller is additionally configured to monitor an ambient temperature and regulate the mechanism to select and lock a second predetermined position of the shutter in response to the ambient temperature being below a predetermined value.

15. A method of controlling operation of an adjustable shutter in a vehicle having an internal combustion engine, the method comprising:
operating by a controller a mechanism configured to adjust the shutter between and inclusive of fully-opened and fully-closed positions to regulate an amount of ambient air flowing into an air intake of the engine, wherein the shutter is arranged relative to a vehicle grille opening adapted for receiving ambient air flowing into the air intake;
sensing, via a moisture sensor, a level of moisture in the ambient air; and
selecting a first predetermined position of the shutter when the level of moisture has reached a threshold moisture value to alter the level of moisture in the ambient air flowing into the air intake.

16. The method of claim 15, further comprising communicating by the moisture sensor to the controller a signal indicative of the sensed level of moisture.

17. The method of claim 15, further comprising monitoring an ambient temperature by the controller and operating the mechanism to select and lock a second predetermined position of the shutter in response to the ambient temperature being below a predetermined value.

18. The method of claim 15, wherein the air intake is characterized by an absence of baffles configured to substantially separate the flow of ambient air from the moisture.

19. The method of claim 15, further comprising monitoring a temperature of the engine by the controller, wherein said operating the shutter is accomplished in response to a change in the temperature of the engine.

20. The method of claim 15, wherein the threshold moisture value is near 100% humidity and the first predetermined position of the shutter is that of fully-closed.
